(19) United States
(12) Patent Application Publication
(10) Pub. No.: US 2020/0239318 A1
(43) Pub. Date: Jul. 30, 2020

(54) Highly-Functionalized Carbon Materials for the Removal of Inorganic and Organic Contaminants

(71) Applicant: Tusaar Corp., Lafayette, CO (US)

(72) Inventors: Gary L. Carlson, Broomfield, CO (US); Timothy J. Lanyk, Lafayette, CO (US); George E. Yates, Broomfield, CO (US); Dean P. Stull, Longmont, CO (US); Gautam Khanna, Louisville, CO (US)

(21) Appl. No.: 16/750,761

(22) Filed: Jan. 23, 2020

Related U.S. Application Data
(60) Provisional application No. 62/796,785, filed on Jan. 25, 2019.

(51) Int. Cl. C01B 32/30

(52) U.S. Cl. CPC C01B 32/30; C01P 2006/90

(57) ABSTRACT

A carbon material for contaminant removal performance. The carbon material having an equilibrium pH (pH_{eq}) between about 1.5 and about 9, a total acidic functionality (TAF) between about 0.8 and about 3 mequiv./g-C and a cation sorption capacity of greater than about 70 cmmol/kg-C. The carbon material identified by determining an pH_{eq} of the carbon material contacted with an electrolyte solution. The carbon material identified by quantifying TAF by acid-base titrations. The carbon material identified by generating a proton binding curve from the acid-base titrations. The carbon material identified by integrating the calculated f(pK) distribution from the proton binding curve. The carbon material identified by determining equilibrium isotherms and converting the data into a cation sorption capacity. The carbon material identified by comparing the cation sorptive capacity of the carbon material to a predetermined range of cation sorptive capacity to identify the carbon material.

### PRIORITY CLAIM

This application claims the priority benefit of U.S. Provisional Patent Application No. 62/796,785 filed Jan. 25, 2019 titled “Highly-Functionalized Carbon Materials for the Removal of Inorganic and Organic Contaminants” of Carlson, et al., hereby incorporated by reference in its entirety as though fully set forth herein.

### BACKGROUND

Activated carbon and carbon char (charcoal) materials have been used for decades to remove impurities such as undesirable odor, color, taste, and to improve the safety of drinking water by removing organic contaminants like chlorinated solvents and other industrial pollutants, pesticides, and select heavy metals. A significant amount of effort has been targeted at the improvement of metals and impurity removal using carbon materials by increasing functionality on exposed surfaces. Elucidation of the chemical/physical functionality with, for example, adsorption and acid-base titration; or on more advanced techniques including FTIR and XPS is critical to product optimization, development, and identification. Unfortunately, advanced techniques are time consuming, expensive, and can be difficult to relate to observed material performance.

### BRIEF DESCRIPTION OF THE DRAWINGS

FIG. 1 shows an example titration curve of an activated carbon material.

FIG. 2 shows an example of a proton binding curve (PBC) from an activated carbon material.

FIG. 3 is a plot of the roughness of the fitted spline function log(G) to the proton binding curve versus the goodness of fit, s.

FIG. 4 shows an example validation of the defined procedure using known organic acids with distinct, multiple pK values.

FIG. 5 shows an example of an analyzed pK distribution for a modified activated carbon material.

FIG. 6 is a plot of the mass of Pb adsorbed per gram of modified carbon material versus the equilibrium concentration of Pb in solution.

FIG. 7 illustrates a wide variety of untreated and treated carbon materials tested with a pH_{eq} range between 2 to 11.2, a TAF range of 0.2 to 2.3 mequiv/g-C, and cation sorption capacity between 2 to over 275 cmmol/kg-C.

### DETAILED DESCRIPTION

Surface modification and functionalization of the surfaces of a carbon material may be implemented to alter the physical and chemical nature of the material to enhance performance for the removal of organics, odors, color and oxidants such as chlorine. Various methods may be employed to produce functional properties on carbon material surfaces, including but not limited to, oxidation by utilizing liquid and gaseous oxidants, grafting of functional groups onto the material surfaces, physisorption of ligands, vapor deposition, and/or functional groups developed during carbon activation processes.

Differentiating these modified carbon materials can be important to manufacturers of these carbon materials to ensure that proprietary carbon materials are not being sold or distributed without authorization (e.g., on the “black market”).

Careful examination of various measured chemical and physical properties of carbon materials subjected to a wide variety of activation and post-activation treatment techniques show clearly defined differences when specific chemical/physical properties are related to one another. For example, the relationship between parameters from simple analytical techniques, when measured by acid-base titrations, sorption isotherms, and solution pH after contact with carbon materials, provides a defined parametric space that is unique for certain carbon materials of interest. Comparison of these parameters for different carbon materials can be implemented to differentiate the carbon material of one manufacturer from that of another manufacturer.

By way of illustration, analysis techniques such as but not limited to total acidity determined by pK distributions from titration data, adsorption isotherm data, and equilibrium contact pH are used to characterize, identify, and differentiate modified carbon materials from different manufacturers.

The disclosure herein relates to identifying chemical and physical properties of carbon surfaces that are specific to the Applicant's carbon material which have been treated with various techniques, to carbon materials (treated or untreated) of other manufacturers. Combinations of these measured properties can be implemented to differentiate one carbon material from another carbon material.

In an example, the unique combination of properties identifies a carbon material that has been produced using the Applicant's processes and carbon surface treatment methods. That carbon material has an equilibrium pH (pH_{eq}) between about 1.5 and about 9; a total acidic functionality (TAF) between about 0.8 and about 3 mequiv./g-C; and a cation sorption capacity of greater than about 70 cmmol/kg-C.

Analyses of the carbon materials according to the disclosure herein is by standardized analysis techniques, such as acid-base titrations, elemental analysis, iodine number, methylene blue number, and thermogravimetric analysis to quantitatively and qualitatively (e.g., by Boehm titration), to determine the properties of activated carbon surfaces.

One such analysis technique, acid-base titration, includes monitoring pH response versus the amount of titrant added. Although there are differences that can be employed during the titration methodology, such as titrant concentration, dose rate, length of time of measurements, etc., the results provide information that can be utilized to determine chemical functionality on the surface of carbon materials.

This titration information is then converted into a “proton binding curve” (PBC), which is unique to each carbon material. This curve provides information on the ability of the carbon material to adsorb or release protons [H+] from its surface. The PBC from each material is then analyzed mathematically to obtain a distribution of pK values versus pH providing a functional “fingerprint” of the material.

The total amount of total acidic functionality (TAF) is determined from the distribution of pK values and related to other measurable quantities such as pH equilibrium in a dilute ionic water solution and cation sorption capacity. These measurable quantities do not require knowledge of the treatment process applied to the carbon material.

Correlations between measured properties of carbon materials to the removal of inorganic/organic contaminants in aqueous and non-aqueous solutions show a unique, definable parametric range for each carbon material, therein differentiating carbon media from others.

In the process of determining activated carbon surface properties, acid-base titration, equilibrium pH measurement, and mathematical data analysis are implemented to characterize targeted surface properties of untreated and treated carbon materials. This characterization methodology provides a detailed analysis of surface and chemical properties that allows differentiation between carbon materials.

In addition to measurable surface properties of the carbon materials, adsorption isotherm performance and cation sorption capacity (cmmol/kg-C) can be used to define a range of functional properties that correlate to high adsorption removal and capacities. Various cations with different valence states can be used as sorbates to define the cationic sorption capacity with final selection ultimately dictated by overall sorption affinity to the carbon material and reliability of results.

Before continuing, it is noted that as used herein, the terms “includes” and “including” mean, but is not limited to, “includes” or “including” and “includes at least” or “including at least.” The term “based on” means “based on” and “based at least in part on.”

In addition, the following terms as used herein are defined as:

Carbon material(s): carbonaceous material produced naturally or industrially; untreated or treated by chemical and/or physical means.

Total Acidic Functionality (TAF): a quantity of titratable functional groups on carbon material surfaces determined from acid-base titration data converted into an acidity distribution function f(pK) and providing an estimate of quantifiable functional groups in mequiv./g-C. The TAF parameter is determined over pH range between about 2.3 to about 10.8.

Cation sorption capacity: the number of millimoles of equivalent positive charge (+) that is adsorbed by a unit mass of carbon material calculated at a specific equilibrium sorbate concentration. Cation sorption capacity is calculated by taking the mass of sorbate adsorbed by the carbon material divided by the molar mass and the charge number of the cationic sorbate with this value divided by the mass of carbon material to obtain cmmol/kg-C.

Measured properties: quantifiable properties from direct measurements including both chemical and physical attributes of carbon materials and carbon surfaces.

It is also noted that the examples described herein are provided for purposes of illustration, and are not intended to be limiting. In an example, the components and connections depicted in the figures may be used. Other devices and/or device configurations may be utilized to carry out the operations described herein. Likewise, the operations shown and described herein are provided to illustrate example implementations. However, the operations are not limited to the ordering shown. Still other operations may also be implemented and/or improved.

It is noted that the carbon material may be modified according to any of a variety of different techniques over a wide range of temperatures. Carbon surface modification methods which may be implemented include, but are not limited to, oxidation by inorganic acids including nitric, sulfuric, phosphoric, hydrochloric, and any combination thereof; inorganic oxidants such as perchlorate, permanganate, activated oxygen species, or ammonium persulfate; peroxides, metal peroxides, and peroxy-acids including hydrogen peroxide, peroxymonosulfuric acid, peracetic acid, sodium peroxide, calcium peroxide, and potassium peroxide; addition of organic ligands including benzotriazole type, EDTA, mono- and poly-carboxylic acids such as malic acid, picolinic acid, and citric acid; grafting of terminal alcohols, terminal amines, and carboxylic acids by using diazonium salts, organic silanes, mono- and poly-carboxylic acids, and acidic alcohols; post-treatment of oxidized carbon surfaces with alkaline materials including sodium hydroxide, ammonium hydroxide, bicarbonate, carbonate, ethoxides, and other alkali/alkali earth hydroxides/carbonates; and media modification by the addition of alkaline earth metals or transition metals to form metal oxides and/or complexes

The disclosure defines correlations between measured and calculated values of the total number of quantifiable acid groups, equilibrium contact pH between carbon materials in dilute ionic solutions, and cation sorption capacity of carbon materials produced by using various surface treatment methods; to identify the media materials and differentiate the inventor's carbon materials from others.

An example technique establishes a range of physical and chemical properties that uniquely identifies, defines, and characterizes carbon materials by defining analytical methodologies and analyses that provide correlations between measurable quantities and performance metrics distinctive to these materials.

An example technique relates information obtained from the following analytical and data analysis: acid-base titration, water contact pH, proton binding curve, determination of continuous pK distribution, and equilibrium adsorption isotherms.

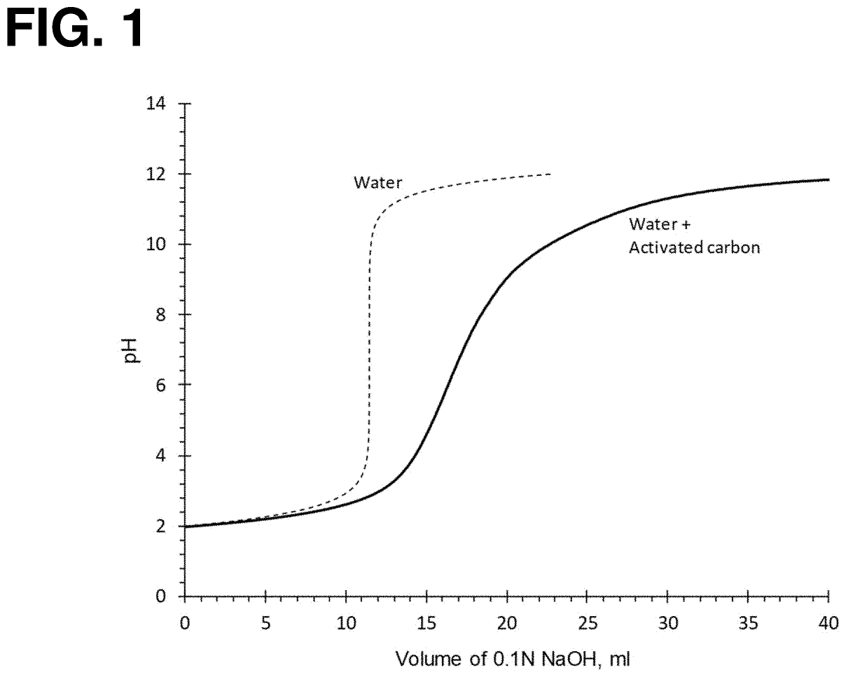

FIG. 1 shows an example titration curve of an activated carbon material. An example acid-base titration method includes: grinding of 0.6-g of the carbon sample to pass through a 450 US mesh screen; transferring 0.5 g of the ground material into a 250-ml side-arm Erlenmeyer flask; addition of 100-ml of a 0.01 molar solution of NaNO₃ into the flask; placing the carbon-slurry solution under vacuum for 60 minutes; transferring the carbon slurry into an automatic titrator (Hanna Instruments, Model HI 902) sealed titration vessel; mixing the solution for 90 minutes under a nitrogen gas (N₂) atmosphere; measuring equilibrium carbon contact pH with a dual-junction pH probe (Hanna Instruments HI-1131 or similar); adding 0.05 ml aliquots of base titrant consisting of 0.01 molar NaOH or KOH at timed intervals; and recording pH change after each titrant addition.

The procedure of water contact pH follows the procedure outlined by ASTM Method 383-80 “Standard Test Method for pH of Activated Carbon” or ASTM D-6851-02 “Standard Test Method for Determination of Contact pH with Activated Carbon.”

The procedure for determination of the continuous acid functionality distribution the generation of the proton binding curve (PBC) from titration data involves converting the alkalimetric titration data into a binding curve of protons on the carbon surface by using the following relationship:

Q=(1/m)[V₀{[H⁺]ᵢ—[OH⁻]ᵢ}—VₜNₜ—(V₀+Vₜ){[H⁺]_{f}—[OH⁻]_{f}}] Equation 1:
where
Q=protons adsorbed or released from the carbon surface, mequiv./g-C
Vₒ=initial titration volume, L
Vₒ=cumulative titrate volume added, L
Nₜ=normality of titrant (neg. for base, pos. for acid)
[H⁺]ⱼ=initial proton concentration, moles/L
[H⁺]_{f}=proton concentration at titrant addition, moles/L
[OH⁻]ᵢ=initial hydroxyl concentration, moles/L
[OH⁻]_{f}=hydroxyl concentration at titrant addition, moles/L
m=mass of carbon, g

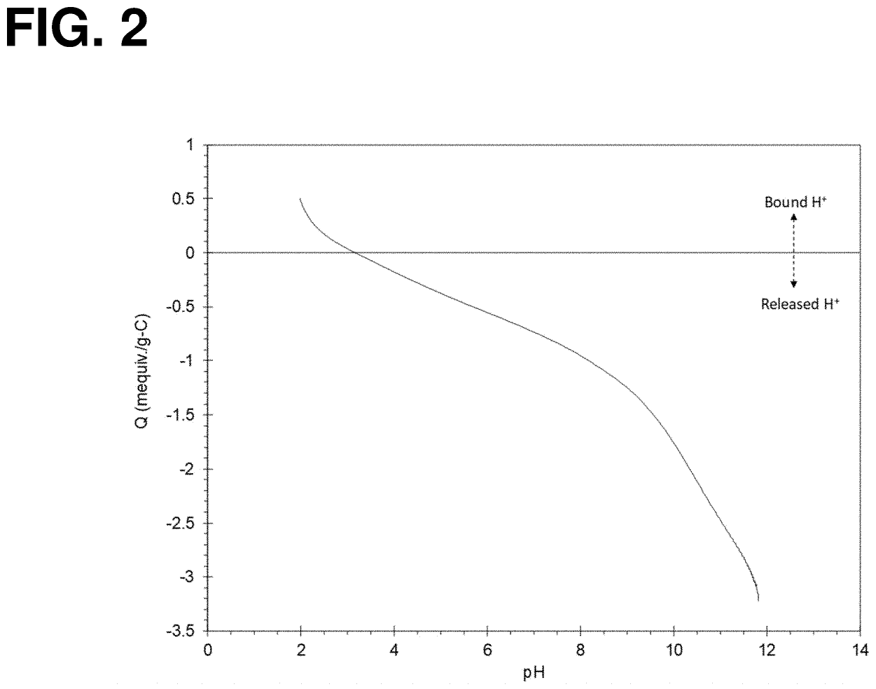

This relationship simply calculates the difference between the number of protons (H+) neutralized by the addition of hydroxide ions (OH−) necessary to change the pH from the initial pH before titrant addition to the pH after titrant addition from the number of protons neutralized (or gained) on the carbon surface. An example of a proton binding curve (PBC) from an activated carbon material is presented in FIG. 2.

FIG. 2 shows an example of a proton binding curve (PBC) from an activated carbon material. Analyzing acid-base titration data by converting into a proton binding curve and subsequent transformation into a continuous pK distribution (acidity distribution function) provides a comprehensive characterization of surface acid functionalities at any measurable pH value. In an example, each acidic site on the carbon surface is characterized by an individual acid constant, K. The pK distribution of these acidic constants can be modeled by a continuous function f(pK) defined as the number of acid-base functionalities with constant acidity in a measured pH interval between pK and pK+DpK. The proton binding curve (PBC) is related to the acidic functionality distribution by the following integral equation:

$$Q ( pH ) = {{\int }^{pK + dpK}}_{pK} \frac{K}{K + [ {H}^{+} ]} f ( pK ) dpK \qquad Equation 2$$

where
Q(pH)=measured proton binding at given pH, mequiv./g-C
pK=corresponding pH value at acid dissociation constant, K
dpK=interval of acidity constant
[H⁺]=pH of solution
f(pK)=distribution function of acidic sites in terms of their pK values

The challenging aspect of this equation is determining the f(pK) distribution function, which is a differential, non-normalized quantity. A method that works well is based upon a local solution of the adsorption integral equation based upon adsorption energy distributions from gas-solid adsorption isotherms, in which the solution is given by the following series:

$$f ( pK ) = [ - \frac{\partial Q ( pH )}{\partial ( pH )} + \frac{{π}^{2}}{31 {ln}^{2} ( 10 )} \frac{{\partial }^{3} Q ( pH )}{\partial {( pH )}^{3}} - {\frac{{π}^{4}}{51 {ln}^{4} ( 10 )} \frac{{\partial }^{5} Q ( pH )}{\partial {( pH )}^{5}} + … ]}_{pH = pK} \qquad Equation 3$$

Calculated f(pK) values are based upon using the first two or three terms of the series where the first two terms in Equation 3 include the first and third-derivatives of the proton binding curve, whereas the addition of the third term in Equation 3 adds the fifth-derivative. These derivatives are calculated at each Q value for a given pH by fitting a smoothing cubic spline through each set of data points. The proton binding data versus pH is approximated by a cubic spline function g(x) that minimizes the following function:

$$\frac{1}{N} {\sum }_{i = 1}^{i = N} {[ g ( {x}_{i} ) - {y}_{i} ]}^{2} + λ {{\int }^{{X}_{N}}}_{{X}_{1}} {[ {g}^{″} ( x ) ]}^{2} dx = minimum \\ {s}^{2} + λ G = minimum \qquad Equation 4$$

where
N number of experimental points
xᵢ=x coordinate of point Nᵢ
yᵢ=y coordinate of point Nᵢ
i=smoothing parameter, 0 to 1

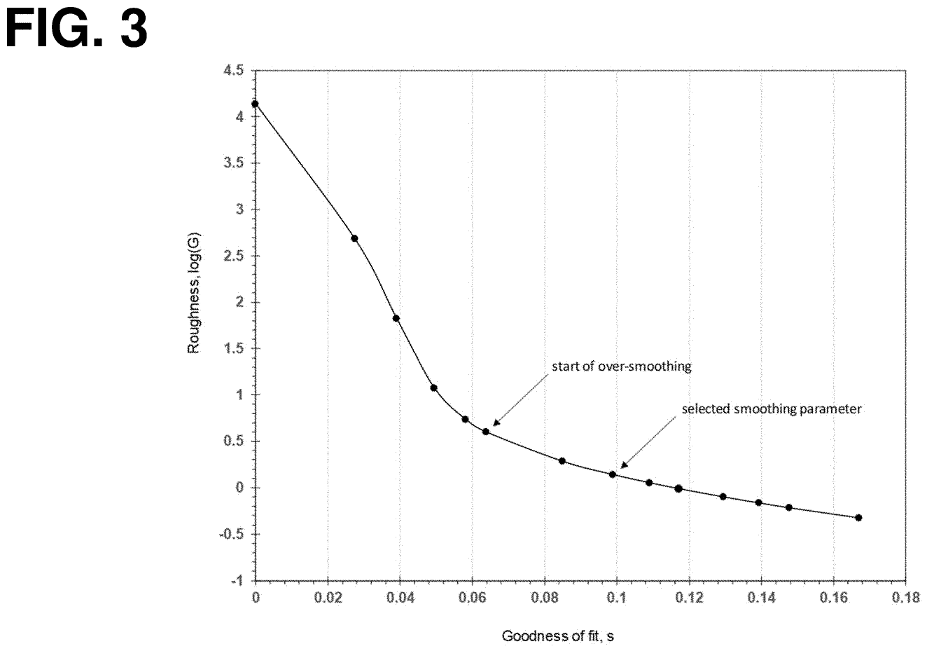

The smoothing parameter (lambda) balances the “roughness” of the original proton binding curve between two successive pH values and goodness of fit of the smoothed cubic spline function. Deciding what degree of smoothing is required is determined by plotting the roughness of the fitted spline function log(G) to the proton binding curve versus the goodness of fit, s. A typical plot is provided in FIG. 3.

FIG. 3 is a plot of the roughness of the fitted spline function log(G) to the proton binding curve versus the goodness of fit, s. The shape of the curve in FIG. 3 shows a rapid decrease in roughness by smoothing fluctuations in the derived smoothing splines followed by a region of over smoothing as log(G) does not change as quickly as the goodness of fit. It has been shown that selecting a value of the smoothing parameter (lambda) slightly after the point where over-smoothing begins provides the best balance of smoothing and retention of critical f(pK) distribution data.

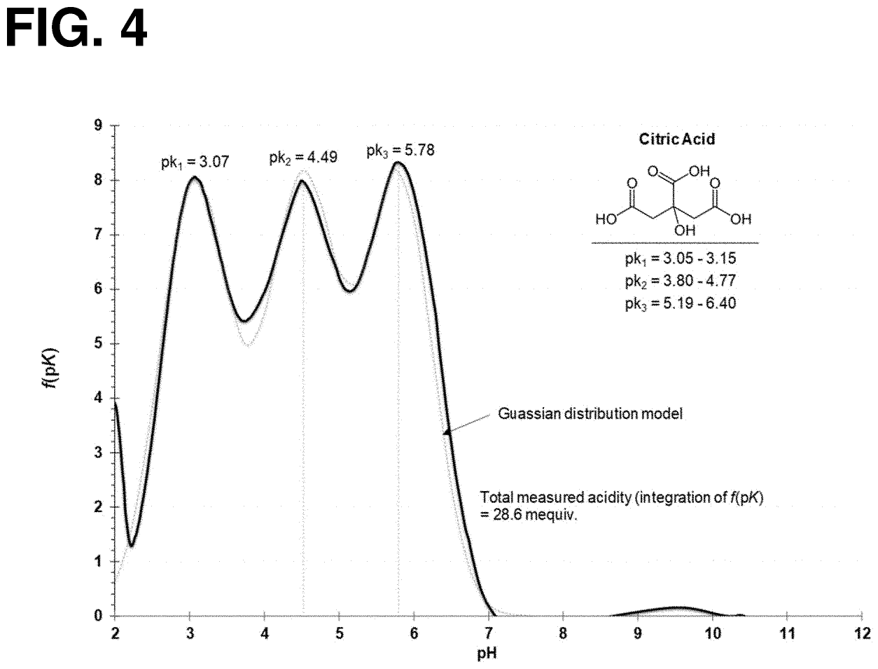

Validation of the defined procedure was obtained by using known organic acids with distinct, multiple pK values. An example of method validation is shown in FIG. 4 in which a 10 mmol (30 milli-equivalents of total acidity) solution of citric acid was titrated with NaOH and converted into a PBC and corresponding f(pK) distribution.

FIG. 4 shows an example validation of the defined procedure using known organic acids with distinct, multiple pK values. It can be seen that the conversion of the titration curve into a proton binding curve with deconvolution into a corresponding pK distribution accurately identified the three pK values of citric acid along with quantifying total acidity within 95% (28.6 compared to 30 milli-equivalents).

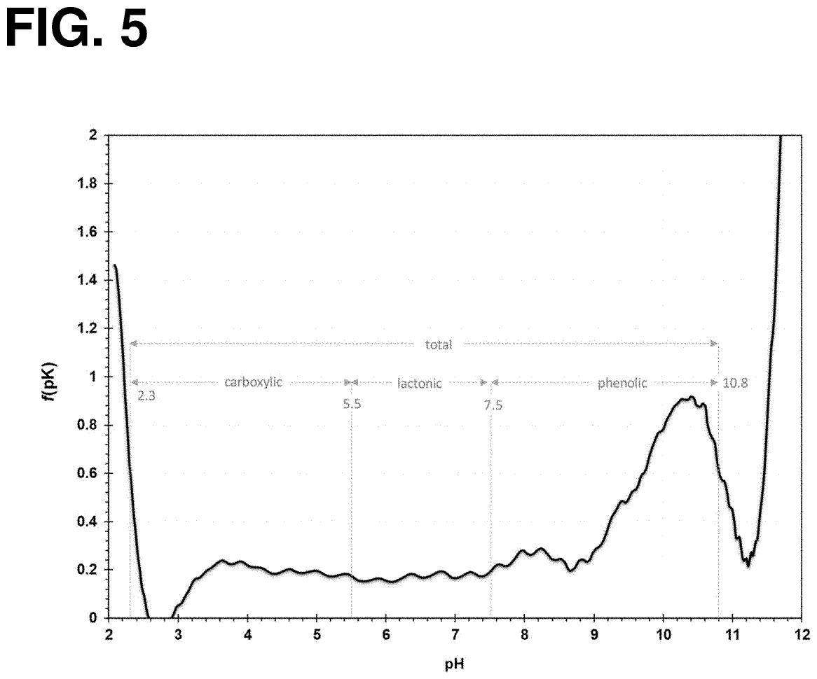

FIG. 5 shows an example of an analyzed pK distribution for a modified activated carbon material. Total acid functionality is calculated by integration under the f(pK) curve between the limits of pH 2.3 to 10.8. These limits represent the bounds of accurate measurement due to the probability that surface groups with pK values outside of this defined range do not react during the alkalimetric titration, although they may bind protons at the very moment of contact with the 0.01N NaNO3 solution.

Calculated functionality may also be separated into three functional acid groupings: carboxylic pH 2.3 to 5.5, lactonic pH 5.5 to 7.5, and phenolic pH 7.5 to 10.8. This provides a convenient method of grouping the pK distribution therein providing general comparison to other materials with defined pKs and to classical Boehm titrations. The total acid functionality (TAF) determined by integration of the f(pK) curve is a critical parameter in defining material properties.

The procedure for the generation of equilibrium isotherms for a given solute follows the procedure outlined by ASTM Method D 5919-96 “Standard Practice for Determination of Adsorptive Capacity of Activated carbon by a Micro-Isotherm Technique for Adsorbates at ppb Concentrations” or ASTM D 3860-98 “Standard Practice for Determination of Adsorptive Capacity of Activated Carbon by Aqueous Phase Isotherm Technique.”

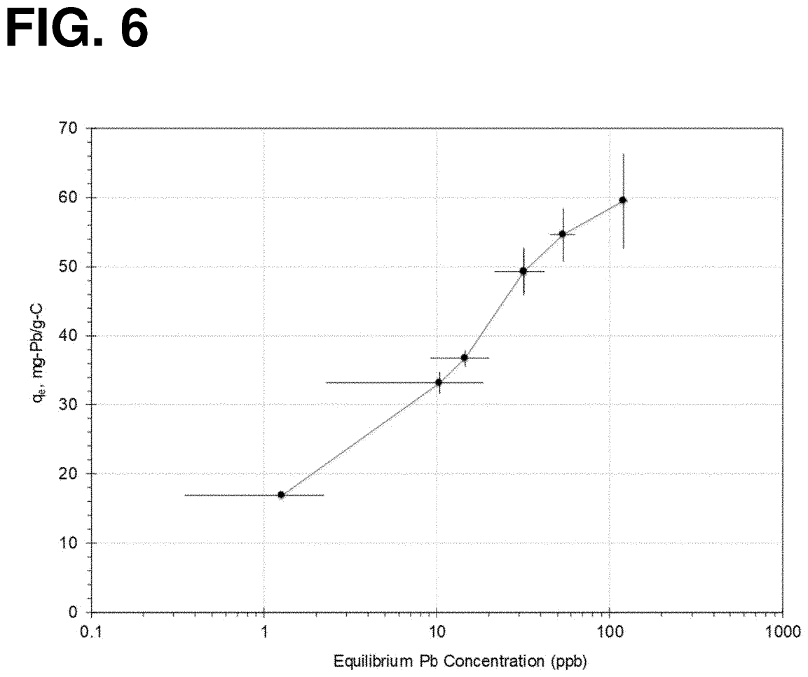

FIG. 6 is a plot of the mass of Pb adsorbed per gram of modified carbon material versus the equilibrium concentration of Pb in solution. The shape of curve shows increasing lead adsorption (capacity) as the equilibrium concentration of Pb increases, consistent with adsorption theory.

Data from the determination of equilibrium sorption isotherms is converted from the mass of sorbate adsorbed per unit mass of carbon material sorbent to the cation sorption capacity given by the number of millimoles of equivalent positive charge adsorbed by a unit mass of carbon material. This conversion allows for the direct comparison of various cationic sorbates with different valence states. One such cation of interest evaluated in detail is Pb, therein providing a functional comparison between treated and untreated carbon materials. Pb was chosen as a target cationic sorbate due to its large ionic radius and challenging sorptive removal characteristics. Cation sorption capacity of Pb was determined using a non-buffered pH solution adjusted to pH 6.5 with initial Pb concentration set at 150-ppb and equilibrium contact time of 24-hrs.

Cation sorption capacity determined from sorption isotherms is analyzed to compare sorption capacities (performance) of activated carbon at various solute equilibrium concentrations to identify those carbon materials that were high and low capacity. The differentiation between these levels is dependent on the solute (sorbate) of interest and the environmental conditions that the isotherm was generated. For example, Pb adsorption at pH 6.5 can be arbitrarily separated into high capacity with cation sorption capacity >70 cmmol/kg-C medium capacity 25-70 cmmol/kg-C, and low capacity <25 cmmol/kg-C when the lead equilibrium concentration in the contact solution is 10 ug/L (ppb). An equilibrium concentration of 10-ppb was chosen because sorption capacity data at high equilibrium concentrations typically show larger differences in capacity therein potentially showing adsorptive differences that do not translate to low equilibrium concentrations. Therefore, a low equilibrium concentration of 10-ppb provides a more robust comparative analysis of cation exchange capacity between different carbon materials. The correlation of high capacity materials for Pb adsorption (>70 cmmol/kg-C) was used to identify and define the parametric region (combination of measured physical parameters).

Based upon the evaluation of seven commercially available activated carbons and over 30 modified activated carbon materials subjected to different treatment methods, the three main parameters of interest used to define unique carbon materials include the equilibrium contact pH of carbon within a 0.01 molar NaNO₃ solution, the calculated total acidic functionality (mequiv./g-carbon) by acid-base titration, and lead cationic sorption capacity at a 10-ppb Pb equilibrium concentration.

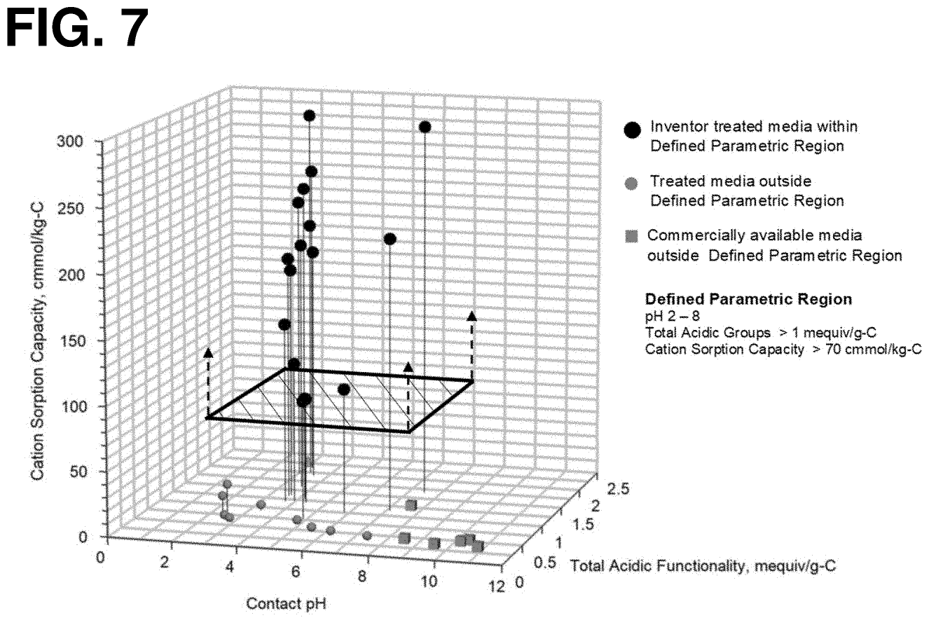

A 3-D plot of calculated TAF versus equilibrium contact pH and Pb cationic sorption capacity defines a parametric region for an equilibrium Pb concentration of 10-ppb (FIG. 7) allowing comparison between modified carbon materials and untreated (virgin) activated carbons.

FIG. 7 illustrates a wide variety of untreated and treated carbon materials tested with a pH_{eq} range between 2.3 to 10.8, a TAF range of 0.2 to 2.3 mequiv/g-C, and lead cationic sorption capacity between 2 to over 200 cmmol/kg-C. Each point (symbol) in FIG. 7 shows the total calculated acidic functionality (TAF) versus equilibrium pH (pH_{eq}) and measured Pb cationic sorption capacity for each carbon material in equilibrium contact with a 10-ppb Pb solution.

There is clear separation between low capacity materials defined as a lead cation sorption capacity <25 cmmol/kg-C in a measured pH_{eq} range between 2.3 to 10.8, a TAF of 0.2 to 0.75 mequiv./L, and high capacity materials defined as a Pb adsorption cation sorption capacity >70 cmmol/kg-C in the region defined between a pH_{eq} between 2 to 8 and a TAF between 1 to 2.4 mequiv/L.

It is seen in FIG. 7 that high performing materials have lower pH_{eq} values and higher calculated TAF values while poor (low) performing materials have representative low TAF values independent of pH_{eq}.

The plot shown in FIG. 7 can be consulted to identify the region of high capacity (>70 cmmol/kg-C) materials. The region includes a unique combination of pH_{eq} and TAF values. Carbon materials within the defined parametric region consisting of a pH range between 2 to 8, a TAF value >1 mequiv/g-C, and an equilibrium Pb cation sorption capacity value >70 cmmol/kg-C at 10-ppb Pb solution equilibrium were produced by the inventor's various treatment methods to modify the carbon surface.

Carbon materials produced with measured values of equilibrium pH, total acidic functionality (TAF), and Pb cation sorption capacity within the defined region of pH range between 2 to 8, a TAF value >1 mequiv/g-C, and an equilibrium Pb cation sorption capacity value >70 cmmol/kg-C at 10-ppb Pb solution equilibrium used as a whole or in part, or mixed with other materials to produce an end product adapted for the removal/separation of inorganic and organic contaminants from liquid and gaseous environments are unique.

In an example, carbon material(s) having high cation sorptive capacity (>70 cmmol/kg-C) shown in the three-dimensional cube of FIG. 7 may be produced according to a treatment process, as follows. 1-kg of activated carbon is mixed with 2.38 liters of H₂0 and 2.38 liters of 15.8 molar (70 wt %) nitric acid (HNO₃). The solution is mixed to ensure complete carbon particle suspension and heated to a temperature of 80° C. The mixed carbon slurry is maintained at temperature for 4 hours. Nitrogen oxide (NO) and carbon monoxide (CO) are produced with gas-headspace concentrations exceeding 100,000 and 8,000 ppm (by gas volume) respectively requiring destruction using viable and appropriate scrubbing/destruction equipment. The solution is cooled ambiently to below 50° C. followed by carbon separation from the oxidation liquor using a pressure filter (SEPOR Inc., Wilmington, Calif.). The carbon slurry mixture is added to the 8-in. diam.×14.5-in. height pressure filter fitted with a 10-um filter paper and operated at 50-psig producing an average effluent flow of 0.25-Ipm. Actual carbon media particle size and overall distribution will affect filtration times and efficiency. The filtered carbon material is removed from the pressure filter and re-mixed with water at a volume/mass dose rate of 0.5 l/kg-dry C. The solution is mixed for 5-min. and returned to the pressure filter. The pressure filter is operated at the same conditions listed above. This sequence of washing the carbon media with water is repeated until the measured pH of the rinse solution is above 4. The rinsed and filtered carbon material is then mixed with 0.1M sodium bicarbonate solution at a volume/mass ratio of 5 L/kg-dry C. The solution is mixed for 2-hrs while monitoring solution pH. The solution pH is adjusted to pH between 6.5 to 7 by adding sodium bicarbonate of HCI and maintained within this range while mixing. The resulting media then pressure filtered as described above and rinsed with water at a volume/mass ratio of 5 L/kg-dry C to remove residual sodium and bicarbonate. This rinsing/filtration process is repeated until residual sodium is below 1-ppm. The treated material is placed in an oven and dried at 100° C. for 24-hrs.

Process variables that can be varied to produce carbon materials within the defined parametric region defined as shown in FIG. 7, include nitric acid concentration between 2 to 10 molar, reaction temperature from 45° C. to 110° C., and contact time between 0.5 to 24 hrs. Carbon material rinsing after nitric acid contact can use a volume/mass ratio between 2 to 10 L/kg-C and can be rinsed to a solution pH between 2 to 6. Rinsed/filtered carbon may be contacted with various neutralizing agents such as sodium bicarbonate, sodium carbonates, or other alkali metal hydroxides/carbonates. Starting carbon materials can vary in type from coal, coconut, wood, biochar, or other manufacturer's proprietary starting materials; with grain size varied between 10 US mesh to less-than 400 US mesh. Starting carbon materials may include carbons (specific) from various manufacturers such as Kuraray (GW, GH, GG, GW-H, PGW-20MP, PGWHH-20MDT), Jacobi (AquaSorb CT, CX, CX-MCA, HSN, HX, WT , WX, HAC, X7100H), Cabot, JB, Haycarb, ActiveChar, KX, and Oxbow; or others. Variations detailed above combined with undisclosed proprietary manufacturing processes undertaken by the carbon manufacturers will produce variations that may cause the final product to may not meet the defined parameters.

It is noted that the examples shown and described are provided for purposes of illustration and are not intended to be limiting. Still other examples are also contemplated.

1. A carbon material having unique physical and chemical properties comprising:
an equilibrium pH (pH_{eq}) between about 1.5 and about 9;
a total acidic functionality (TAF) above about 0.8 mequiv./g-C; and
a cation sorption capacity of greater than about 70 cmmol/kg-C.

2. The carbon material of claim 1, wherein the cation sorption capacity is determined by exposure to a lead (Pb) solution.

3. The carbon material of claim 2, wherein the Pb solution is at a pH of about 6.5.

4. The carbon material of claim 2, wherein the cation sorption capacity is determined at an equilibrium lead (Pb) concentration in solution of about 10 ppb.

5. The carbon material of claim 1, further comprising a capacity to adsorb inorganic and organic constituents from gas and liquid phase environments.

6. The carbon material of claim 1, wherein the pH_{eq} is between 2 and 8.

7. The carbon material of claim 1, wherein the TAF is between 1.0 to 3 mequiv./g-C.

8. A carbon material for contaminant removal performance identified by measuring physical and chemical properties comprising:
determining an equilibrium pH (pH_{eq}) of the carbon material contacted with an electrolyte solution;
quantifying total acidic functionality (TAF) by acid-base titrations;
generating a proton binding curve (PBC) from the acid-base titrations;
integrating the calculated f(pK) distribution from the proton binding curve;
determining equilibrium isotherms having isotherm adsorption data;
converting the isotherm adsorption data into a cation sorption capacity using molar mass and valence charge of the carbon material; and
comparing the cation sorptive capacity of the carbon material to a predetermined range of cation sorptive capacity to identify the carbon material.

9. The carbon material of claim 8, wherein the acid-base titrations are with a NaOH and KOH titrant.

10. The carbon material of claim 9, wherein the titrant is between 0.05 to 0.2 molar.

11. The carbon material of claim 10, wherein the titration is with a 0.05 to 0.1 ml/dose rate.

12. The carbon material of claim 11, further comprising a 120 to 180 second equilibrium period between doses of titrants.

13. The carbon material of claim 8, wherein the acid-base titrations are between pH 1.5 to pH 12 under a nitrogen gas atmosphere.

14. The carbon material of claim 8, wherein the electrolyte solution is a sodium nitrate solution.

15. The carbon material of claim 8, wherein the TAF is measured in milli-equivalents per gram of carbon.

16. The carbon material of claim 8, further comprising an equilibrium pH (pH_{eq}) between about 1.5 and about 9, a total acidic functionality (TAF) between about 0.8 and about 3 mequiv./g-C and a cation sorption capacity of greater than about 70 cmmol/kg-C.

17. A carbon material for contaminant removal performance having an equilibrium pH (pH_{eq}) between about 1.5 and about 9, a total acidic functionality (TAF) between about 0.8 and about 3 mequiv./g-C and a cation sorption capacity of greater than about 70 cmmol/kg-C., the carbon material further identified by a method comprising:
determining an equilibrium pH (pH_{eq}) of the carbon material contacted with an electrolyte solution for about 30 to about 120 minutes;
quantifying total acidic functionality (TAF) by acid-base titrations, the TAF measured in milli-equivalents per gram of carbon;
generating a proton binding curve (PBC) from the acid-base titrations;
integrating the calculated f(pK) distribution from the proton binding curve;
determining equilibrium isotherms having isotherm adsorption data;
converting the isotherm adsorption data into a cation sorption capacity using molar mass and valence charge of the carbon material; and
comparing the cation sorptive capacity of the carbon material to a predetermined range of cation sorptive capacity to identify the carbon material.

18. The carbon material of claim 17, wherein the acid-base titrations are with a NaOH and KOH titrant, the titrant is between 0.05 to 0.2 molar, the titration is with a 0.05 to 0.1 ml/dose rate, and the titration is between pH 1.5 to pH 12 in a nitrogen gas atmosphere.

19. The carbon material of claim 17, wherein the acid-base titrations further comprise a 120 to 180 second equilibrium period between doses of titrants.

20. The carbon material of claim 17, wherein the electrolyte solution is a 0.01 molar sodium nitrate solution.
